(19) United States
(12) Patent Application Publication
(10) Pub. No.: US 2005/0100432 A1
(43) Pub. Date: May 12, 2005

(54) Grapple and boom assemblies with compact roller arm power tilt mechanisms

(76) Inventors: Randall D. Mattson, (US); Randy A. Gregory, Spokane, WA (US)

Correspondence Address: GREGORY I.P. LAW, P.O. BOX 31090, SPOKANE, WA, 99223-3018, US

(21) Appl. No.: 10/704,198

(22) Filed: Nov. 7, 2003

(51) Int. Cl. B66C 1/00

(52) U.S. Cl. 414/732

(57) ABSTRACT

Disclosed is a grapple and boom assembly with power tilt mechanism that can be controlled into an engaged position to tilt the grapple relative to the boom. The tilt mechanisms use a push arm that is mounted on the boom at a joint, such as to pivot. A push arm actuator is joined to the push arm to power operation thereof by extension or contraction of the actuator. The push arm includes a movable contact element, such as a roller that bears upon a trackway mounted upon the grapple assembly below the main pivot. A second version is shown wherein two tilt mechanisms are included one below and one above to provide power tilt in either direction yet allow the grapple to be operated in a free suspension mode when desired.

### TECHNICAL FIELD

The invention relates to grapples that are mounted on booms and equipped for adjustable angular orientation of the grapple.

### BACKGROUND OF THE INVENTION

It has been found desirous to have power control of the angle of a grapple mounted on a boom. A typical application for grapples is in the timber industry where logs are picked up and moved. Due to the various slopes and roughness of the terrain, the grapple is more easily maneuvered and achieves better control if provided with a power pivot connection that allows the grapple to be angled for interaction with the load being engaged.

Most prior art grapples having tilt angle control have the grapple fixed to the actuator. This configuration has disadvantages when the logs are being pulled because the forces developed may increase due to the tilt angle established by the actuator. Such configuration may cause mechanical failures of the grapple, boom or tilt actuator because of such incidentally increased forces. Free suspension of the grapple during such operations has advantages in performing machine operations and aids in reducing machine maintenance.

Another problem associated with prior grapple arrangements are the size of the units. Many have extending parts which can impede operation, reduce visibility and cause potential safety risks to the operator or workers in the surrounding area. Extending parts may also become entangled in tree limbs and brush which may slow operations. Thus it is desirable to have a power is tilting grapple which has minimal extensions from the boom and grapple assembly and is compact and relatively light in weight.

It is also important in equipment of this type to have components which are simple, reliable and strong. This allows the equipment to maintain operations despite adverse conditions and extended field operation assignments. Rugged parts not subject to failure are of particular advantage.

In many log skidders, the boom is constructed using a boom having a singular member. However, greater flexibility of operation is provided by booms having two or more boom members that can be controlled independently. These multi-section booms often have close working spaces and this additionally requires compact arrangement of any tilting mechanism that may be employed.

The majority of log skidders having booms and grapples do not have any ability to power tilt the grapple relative to the boom. These machines typically have some form of damping system to reduce free swinging of the grapple hung from its supporting grapple mounting joint. However, such damping systems (sometimes called “snubbers”) do nothing to provide controlled tilt positioning of the grapple. Thus, there is also a large need for a power tilt mechanism that can be easily retrofit onto existing booms and grapples to provide this improved operation and functionality. The numerous different designs of booms and grapples from different manufacturers, models and years causes difficulties in creating a one or a small number of designs that can be mounted upon a wide variety of machinery.

One or more of these and other problems of the prior art are addressed by the invention described herein. Other advantages and benefits of the current invention will be apparent from the description given herein or may be first appreciated upon further use of the invention.

### BRIEF DESCRIPTION OF THE DRAWINGS

Preferred embodiments of the invention are described below with reference to the following accompanying drawings.

FIG. 1 is a side elevational view of a forestry tractor fitted with a boom and grapple assembly according to a preferred version of this invention.

FIG. 2 is a side elevational view of the tractor of FIG. 1 with the boom and grapple assembly adjusted so the grapple is in a tilted orientation.

FIG. 3 is a side elevational view of selected portions of the boom and grapple assembly shown in FIG. 1. The grapple is shown in a freely suspended position relative to the main pivot.

FIG. 4 is a side elevational view similar to FIG. 3 with the grapple shown further tilted.

FIG. 5 is a side elevational view similar to FIGS. 3 and 4 with the grapple shown still further tilted and the boom extended.

FIG. 6 is a perspective view showing the boom and grapple assembly of FIG. 1 in a different position to illustrate additional features of the grapple.

FIG. 7 is a schematic side elevational view of a second embodiment boom and grapple assembly fitted with power tilt mechanisms according to another version of the invention.

FIG. 8 is a schematic side elevation view of the assembly shown in FIG. 7 moved into a more inwardly tilted position.

### DETAILED DESCRIPTION OF THE PREFERRED EMBODIMENTS

Introductory Note

The readers of this document should understand that the embodiments described herein may be defined by relying on terminology used in any section of this document and other terms readily apparent from the drawings and language common therefor. This document is premised upon using one or more terms with one embodiment that will in general apply to other embodiments for similar structures, functions, features and aspects of the invention. Wording used in the claims is also descriptive of the invention. Terminology used with one, some or all embodiments may be used for describing and defining the technology and exclusive rights associated herewith unless specifically indicated otherwise.

Introduction and General Configuration

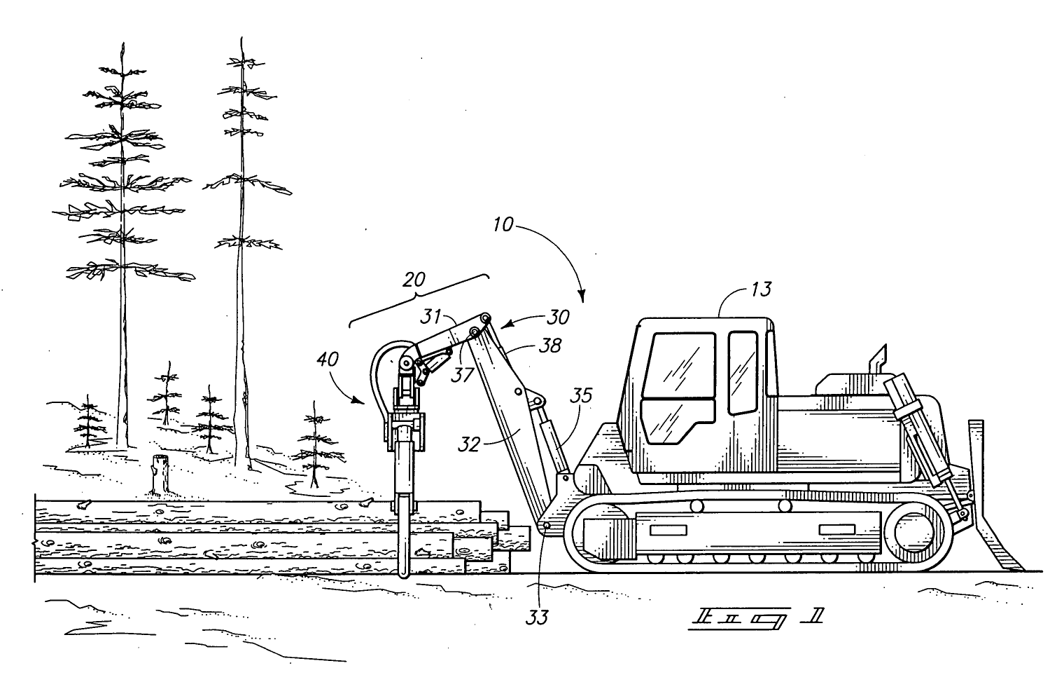

FIG. 1 shows a preferred construction for a boomed grapple machine 10 made according to this invention. The boomed grapple machine 10 includes a vehicle 13. Vehicle 13 is used to transport and facilitate use of a combined boom and grapple assembly 20 which is mounted thereon. The combined boom and grapple assembly 20 has a boom assembly portion 30 and a grapple assembly portion 40.

Vehicle 13 is preferably a tracked vehicle although wheeled or other types of vehicles may be suitable depending upon the terrain and particular use of the boom and grapple machine 10.

Boom Assembly

The boom assembly 30 is used to support the grapple assembly 40 and to position it to the extent of the boom assembly's range of motion. As shown, boom assembly 30 has multiple boom members. The first or jib boom member 31 and a second or main boom member 32 is an exemplary construction although others are possible. The main boom member 32 is joined to the tractor or other vehicle 13 at boom mounting pivot 33. A main boom operator is provided in the form of a linear actuator which is preferably a hydraulic ram or cylinder 35. This actuator 35 contracts or extends to boom up or boom down the main boom member, attached jib member and grapple and tilt assemblies described further hereinafter.

The jib boom member 31 is pivotally connected at jib pivot joint 37. Joint 37 can be made using a variety of conventional bearings or future technology capable of such service. Jib 31 is pivoted using a jib operator in the form of another hydraulic ram 38. Jib actuator 38 is extended to rotate the jib distal end down in a counterclockwise action as illustrated in FIG. 1. Jib actuator 38 is contracted to rotate the jib distal end up in a clockwise action as viewed in FIG. 1. The proximate end of the jib is connected to the jib actuator 38 in pivotal relationship thereto.

The grapple assembly 40 is connected to the distal end of the jib at a main pivot joint 41. Main pivot joint 41 defines a main pivot joint pivot axis which is parallel to the boom pivot axis or axes, such as the pivot axis of jib pivot joint 37 and the pivot axis for main boom pivot joint 33. Main pivot joint 41 may be constructed according to a variety of shaft or bearing arrangements as are now available of hereafter developed. Main pivot joint 41 serves as the connection joint between the boom assembly 30 and the grapple assembly 40.

Grapple Assembly

FIG. 6 shows the grapple assembly 40 well and should be referred to for the following discussion. The grapple assembly can be made according to a variety of conventional or future designs. Grapple assembly 40 is shown with two grapple tongs 48 which are supported by a grapple head 42 at tong pivot joints 43. The grapple tongs may desirably be provided with stabilizer ribs 49 which preferably run to or near the pivot joints 43.

As shown, each grapple tong 48 has a tong operator 44 which is advantageously a hydraulic ram. The tong operating ram 44 is pivotally connected at a lower end to a tong operating shoulder 45 at lower mounting pivot 46. The upper end of operator 44 is pivotally connected to the headpiece 42 at an upper tong operator connection joint 47.

The grapple assembly shown also includes a support linkage 50. Support linkage 50 is connected at the upper end thereof to main pivot joint 41. The support linkage has a linkage member 51 which connect to pivot joint 41. The lower end of the support linkage may advantageously have a secondary pivot joint 52. The pivot axis of secondary joint 52 is spaced from and preferably, orthogonal to the pivot axis of main joint 41.

Secondary joint 52 also preferably has a bottom mounting piece 53 which can be used to mount a swivel operator 54 or it can be formed as part of the swivel operator. The swivel operator is preferably a hydraulic operator that allows the grapple head 42 to pivot about a longitudinal grapple axis. The swivel operator may be limited to a range of motion or be continuously able to swivel in either direction. Hydraulic fluid or other power supply may be connected to the swiveling grapple sub-assembly using hydraulic lines 57. Lines 57 run to the boom and are desirably routed inside the boom members for protection.

Grapple Tilt Mechanism

FIG. 6 and FIGS. 3-5 show a preferred grapple tilt mechanism 70 made in accordance with the inventions. The grapple tilt mechanism 70 can be either provided during original manufacture or added as a retrofit kit installed on a machine similar to machine 10 but without the grapple tilt mechanism. As shown, the grapple tilt mechanism 70 includes at least one mounting bracket, such as boom mounting bracket 71. Boom mounting bracket 71 may be installed by welding to the jib or other boom member to which it is attached.

Mounting bracket 71 includes at least one joint for connection of parts thereto. A push arm or first joint 72 is advantageously provided for joinder of a push arm 73. Push arm joint 72 is preferably a pivotal joint, such as those commonly used in heavy equipment for pivoting parts powered by hydraulics.

The mounting bracket 71 also preferably includes a second or actuator connection joint 75 used to mount one end of a hydraulic ram 76 or other suitable power actuator. The actuator 76 also is joined with the push arm 73 using at least one push arm actuator joint 77. Joint 77 is advantageously a pivotal joint.

Extension of the push arm actuator 76 causes the distal end of the push arm to extend outwardly and toward the grapple is assembly. Contraction of the push arm actuator 76 causes the distal end of the push arm to retract inwardly and away from the grapple assembly.

The push arm 73 is also provided with a movable contact element 78 which is preferably provided in the form of a rocking, swiveling or more preferably a rolling element, such as a roller wheel or wheels, as shown. The contact element is mounted to the push arm at a contact element joint 79 which in the case of the illustrated construction is a pivot joint 79. The construction may include one contact element or several as needed.

The grapple tilt mechanism includes the boom assembly mounted portions described above, and also includes a grapple assembly mounted portions. As shown, the grapple mounted portion is in the form of an elongated trackway or contact plate that is connected to the grapple linkage 50 at a suitable position for engagement by the contact element, such as roller 78. The particular shape of the trackway is variable depedent upon the action and path of the contact element as it engages and moves along the trackway 80. With regard to the construction illustrated, the trackway 80 is welded or bolted to the inboard side of the grapple linkage 50 in proximity to the underboom mounting of the boom portions of the tilt mechanism assembly.

The operation of actuator 76 is preferably accomplished using hydraulic fluid pressurized and supplied through actuator supply lines (not shown). This is done in the convention fashion and control is provided by control valves (not shown) which appropriately supply pressurized fluid to the hydraulic ram to cause extension or contraction as is desired. This is preferably constructed so that actuator 76 has its own independent control valves for independent operation.

Operation & Method for Tilting Grapple Outwardly

FIGS. 3-5 show different boom and grapple assembly i, positions and orientations in a schematic manner. Many elements have been removed for simplicity of illustration and understanding, particularly the lower portions of the grapple assembly are shown disconnected at the secondary joint 52.

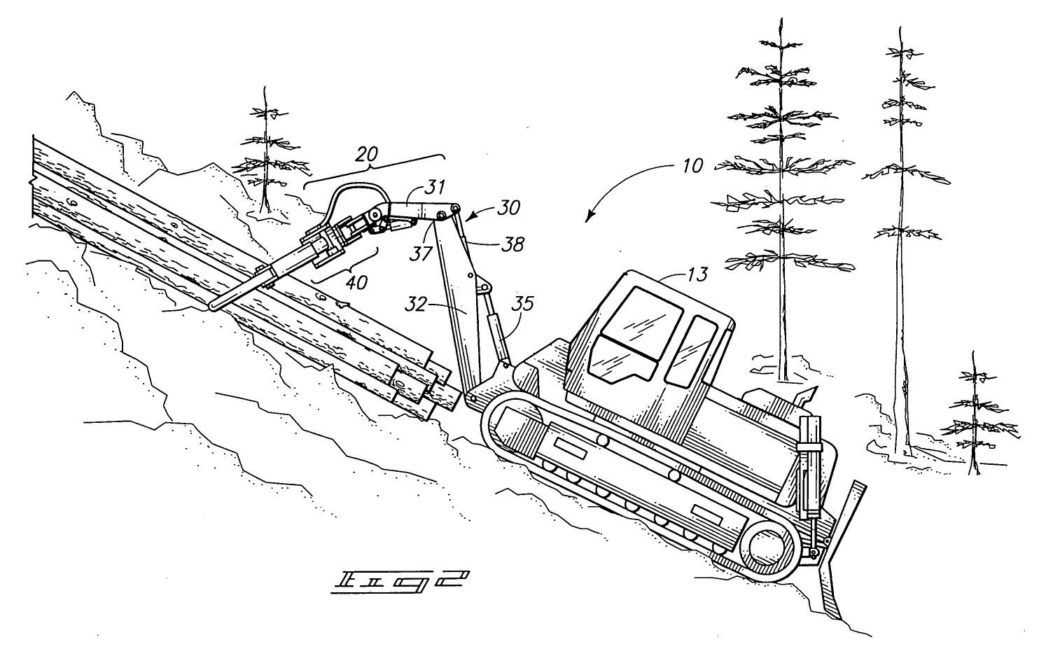

FIG. 3 shows the boom in an extended position with both the main and jib sections extended. The grapple connection link 50 hangs vertically in free suspension from main pivot joint 41. Roller 78 on the push arm is not engaging the trackway piece 80. The grapple linkage is free to swing rearwardly and to a slight degree forwardly in response to forces applied by any load, such as a group of logs as pictured in FIG. 1 or 2.

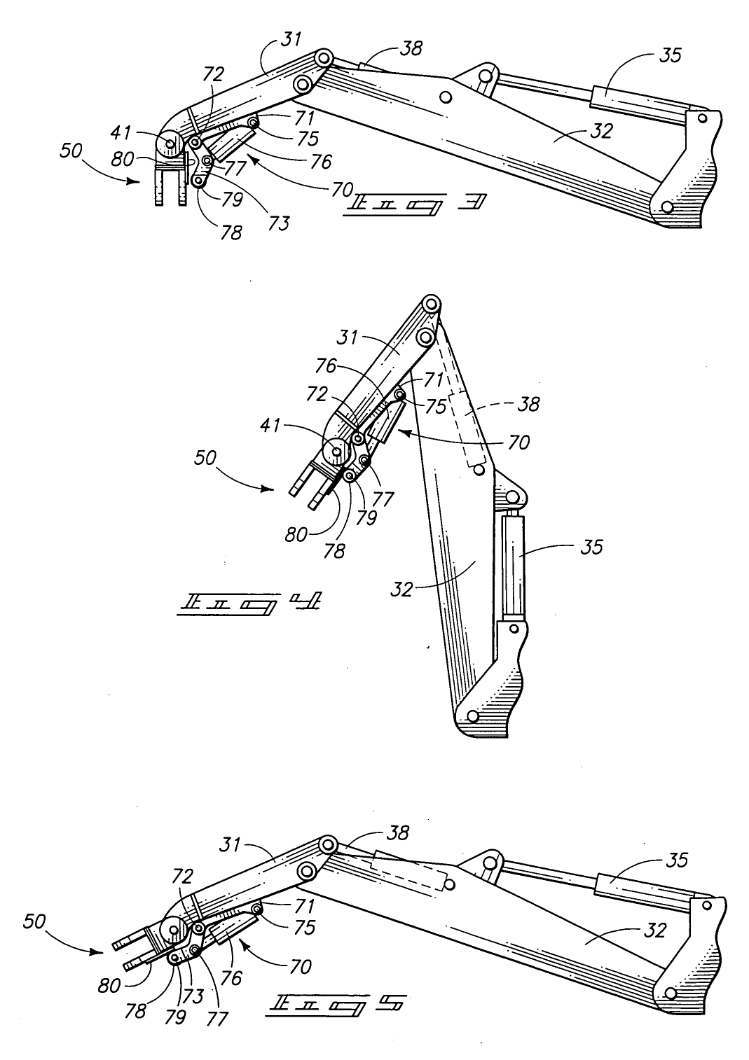

FIG. 4 shows the boom assembly in a forward and contracted position with the jib close to the main boom and the main boom retracted into an upstanding position. Additionally the hydraulic control valves (not shown) controlling flow of hydraulic fluid to the push arm actuator 76 have been controlled to extend the actuator and pivot the contact member 78 into engagement with the trackway 80 and force the grapple assembly to tilt backwardly about main pivot 41. As this is done the contact member, such as roller 78, rolls or otherwise moves across the trackway 80.

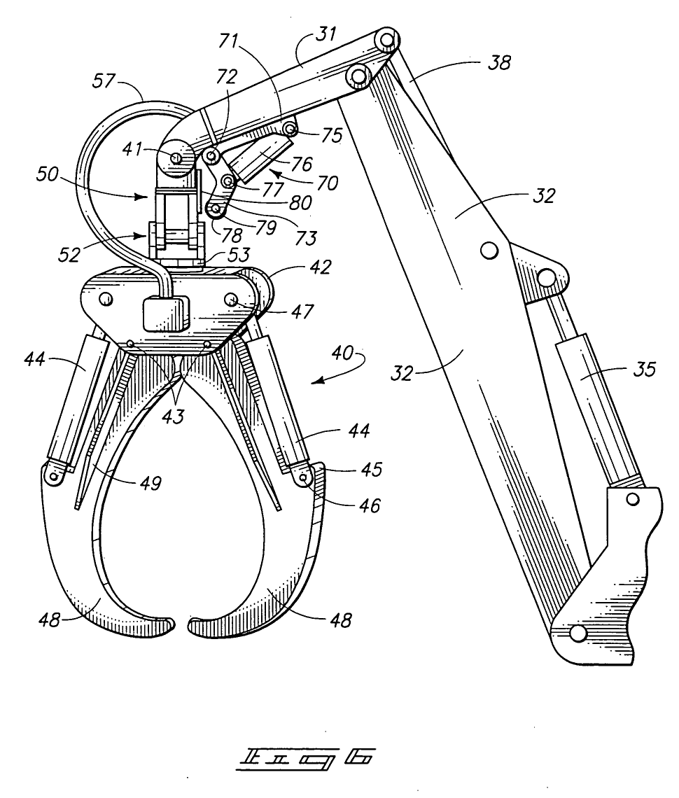

FIG. 5 shows the grapple extended using the tilt mechanism with the boom assembly now moved to an extended position. This allows further tilt of the grapple and extends the grapple further from the vehicle to which it is attached.

The steps of the novel methods may include extending a push arm mounted upon the boom assembly for movement using a power actuator. The methods may further include engaging a roller or other movable contact member or members against a trackway mounted on the grapple assembly. The methods further preferably include moving the movable contact member upon or across the trackway, such as by rolling a roller contact member or members against the trackway by further extending the push arm using the push arm actuator. The resulting tilting of the grapple assembly relative to the boom assembly by said further extending allows the grapple to be repositioned and reoriented into a more tilted position.

Operation and Method for Retracting Tilted Grapple Inwardly

The retraction of tilt mechanism 70 is the reverse of the extension operation explained above. It involves contracting the actuator 76 which causes retracting of the distal end of the push arm 73. Depending upon the initial or starting position of such retraction, the contact element 78 moves, such as rolls downwardly upon the trackway and at a release angle the contact element separates from the trackway to allow free suspension of the grapple assembly.

### Alternative Embodiment

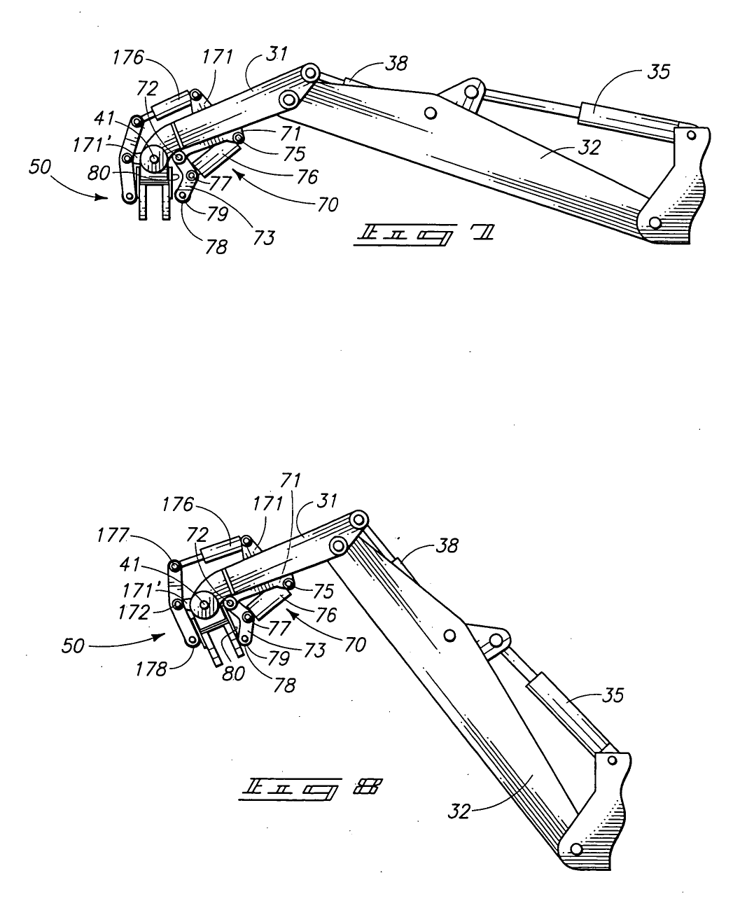

FIGS. 7 and 8 show another possible construction according to the inventions hereof. The construction includes all features described hereinabove and the same reference numerals are used to indicate such features. Description is given above and need not be repeated here.

The construction shown in FIGS. 7 and 8 differs from that of the other figures in that the boom assembly has two opposing tilt mechanisms installed thereon. The first or underside tilt mechanism 70 is described above. The second or overside tilt mechanism 170 is similar to tilt mechanism 70 except it is mounted using two mounting brackets 171 and 171′ that are independently welded to the boom assembly.

Other parts of the second tilt mechanism are similar to those of the first tilt mechanism and are indicated using the same numbers with a leading 100, e.g. actuator 176 versus actuator 76.

The operation of the second tilt mechanism is similar to that of the first tilt mechanism except the trackway is forced inwardly by extension of the actuator 176 and counterclockwise pivotal movement of the push arm 173. The particular shape of the push arm 173 may be varied dependent upon the amount of spacing desired for rearward tilting of the grapple assembly without contact. Retraction of the second tilt mechanism occurs by contraction of actuator 176 which causes push arm 173 to pivot about central pivot joint in a clockwise movement as shown in FIG. 7.

Interpretation Note

The invention has been described in language directed to the current embodiments shown and described with regard to various structural and methodological features. The scope of protection as defined by the claims is not intended to be necessarily limited to the specific features shown and described because other forms and equivalents for implementing the invention can be made and in some cases this is done simple to evade the intended purpose of this

1. An apparatus forming a controllably engaged tilt mechanism for mounting upon a boom and grapple assembly, the boom and grapple assembly having a grapple assembly pivotally connected at a main pivot to a boom assembly, the tilt mechanism being controllable to allow both free suspension and powered tilting of the grapple assembly relative to the boom assembly, comprising:
at least one boom mounting bracket for mounting upon the boom, said at least one boom mounting bracket having at least one joint connection thereon;
at least one push arm having a proximate end and a distal end;
an arm joint toward the proximate end of the at least one push arm connecting the at least one push arm to the at least one boom mounting bracket, and allowing movement of the at least one push arm relative to the at least one boom mounting bracket;
an actuator connection joint on the at least one push arm;
at least one power actuator connected to said at least one boom mounting bracket and said actuator connection joint for moving the at least one push arm relative to the grapple assembly;
at least one contact element mounted upon the at least one push arm, said at least one contact element being mounted for movement relative to the at least one push arm;
at least one trackway for mounting upon the grapple assembly for engagement by said at least one contact element when extended sufficiently, said at least one trackway being:
controllably engaged by said at least one contact element to impart force to pivot the boom assembly about said main pivot; and
controllably disengaged from said at least one contact element to substantially free the boom assembly for free suspension of the grapple assembly from said main pivot.

2. An apparatus according to claim 1 wherein the at least one push arm is bent shaped so as to angle about the main pivot when the at least one push arm is extended.

3. An apparatus according to claim 1 wherein said at least one contact element includes at least one rolling element which, when extended, rolls upon said at least one trackway.

4. An apparatus according to claim 1 wherein said arm joint is a pivotal joint.

5. An apparatus according to claim 1 wherein said actuator connection joint is a pivotal joint.

6. An apparatus according to claim 1 wherein said at least one boom mounting bracket has an arm pivot joint and actuator pivot joint.

7. An apparatus according to claim 1 wherein said at least one boom mounting bracket has an arm pivot joint and actuator pivot joint formed in a single piece.

8. An apparatus according to claim 1 wherein the at least one push arm is bent shaped so as to angle about the main pivot when the at least one push arm is extended, said at actuator connection joint is positioned approximately at an apex in the bent shaped push arm.

9. An apparatus according to claim 1 wherein the at least one boom mounting bracket is mounted with the actuator connection joint along an underside of said boom assembly.

10. An apparatus according to claim 1 wherein the at least one boom mounting bracket is mounted with the actuator connection joint along an upper side of said boom assembly.

11. An apparatus forming a boom and grapple assembly which can be controlled to operate either in free suspension or forced angular displacement, comprising:
a boom assembly having at least one boom member;
a grapple assembly mounted to said boom assembly at a main pivot and having power grapple tongs that can be contracted or separated;
at least one boom mounting bracket for mounting upon the boom, said at least one boom mounting bracket having at least one joint connection thereon;
at least one push arm having a proximate end and a distal end;
an arm joint toward the proximate end of the at least one push arm connecting the at least one push arm to the at least one boom mounting bracket, and allowing movement of the at least one push arm relative to the at least one boom mounting bracket;
an actuator connection joint on the at least one push arm;
at least one power actuator connected to said at least one boom mounting bracket and said actuator connection joint for moving the at least one push arm relative to the grapple assembly;
at least one contact element mounted upon the at least one push arm, said at least one contact element being mounted for movement relative to the at least one push arm;
at least one trackway for mounting upon the grapple assembly for engagement by said at least one contact element when extended sufficiently, said at least one trackway being:
controllably engaged by said at least one contact element to impart force to pivot the boom assembly about said main pivot; and
controllably disengaged from said at least one contact element to substantially free the boom assembly for free suspension of the grapple assembly from said main pivot.

12. An apparatus according to claim 11 wherein the at least one push arm is bent shaped so as to angle about the main pivot when the at least one push arm is extended.

13. An apparatus according to claim 11 wherein said at least one contact element includes at least one rolling element which, when extended, rolls upon said at least one trackway.

14. An apparatus according to claim 11 wherein said arm joint is a pivotal joint.

15. An apparatus according to claim 11 wherein said actuator connection joint is a pivotal joint.

16. An apparatus according to claim 11 wherein said at least one boom mounting bracket has an arm pivot joint and actuator pivot joint.

17. An apparatus according to claim 11 wherein said at least one boom mounting bracket has an arm pivot joint and actuator pivot joint formed in a single piece.

18. An apparatus according to claim 11 wherein the at least one push arm is bent shaped so as to angle about the main pivot when the at least one push arm is extended, said at actuator connection joint is positioned approximately at an apex in the bent shaped push arm.

19. An apparatus according to claim 11 wherein the at least one boom mounting bracket is mounted with the actuator connection joint along an underside of said boom assembly.

20. An apparatus according to claim 11 wherein the at least one boom mounting bracket is mounted with the actuator connection joint along an upper side of said boom assembly.

21. An apparatus according to claim 11 wherein the boom assembly includes a first boom member and a second boom member pivotally connected to said first boom member.

22. An apparatus according to claim 11 wherein the boom assembly and grapple assembly are connected by a connection link which includes parts of said main pivot and parts of a secondary pivot, said main pivot having a main pivot axis which is oriented orthogonal to a secondary pivot axis of said secondary pivot.

23. An apparatus forming a boom and grapple assembly which can be controlled to operate either in free suspension or forced angular displacement, comprising:
a boom assembly having at least one boom member;
a grapple assembly mounted to said boom assembly at a main pivot and having power grapple tongs that can be contracted or separated;
at least one boom mounting bracket for mounting upon the boom, said at least one boom mounting bracket having at least one joint connection thereon;
at least one push arm;
an arm joint on the at least one push arm connecting the at least one push arm to the at least one boom mounting bracket, and allowing movement of the at least one push arm relative to the at least one boom mounting bracket;
an actuator connection joint on the at least one push arm;
at least one power actuator connected to said at least one boom mounting bracket and said actuator connection joint for moving the at least one push arm relative to the grapple assembly;
at least one contact element mounted upon the at least one push arm, said at least one contact element being mounted for movement relative to the at least one push arm;
at least one trackway for mounting upon the grapple assembly for engagement by said at least one contact element when extended sufficiently, said at least one trackway being:
controllably engaged by said at least one contact element to impart force to pivot the boom assembly about said main pivot; and
controllably disengaged from said at least one contact element to substantially free the boom assembly for free suspension of the grapple assembly from said main pivot.

24. An apparatus according to claim 23 wherein the at least one push arm is bent shaped so as to angle about the main pivot when the at least one push arm is extended.

25. An apparatus according to claim 23 wherein said at least one contact element includes at least one rolling element which, when extended, rolls upon said at least one trackway.

26. An apparatus according to claim 23 wherein said arm joint is a pivotal joint.

27. An apparatus according to claim 23 wherein said actuator connection joint is a pivotal joint.

28. An apparatus according to claim 23 wherein said at least one boom mounting bracket has an arm pivot joint and actuator pivot joint.

29. An apparatus according to claim 23 wherein said at least one boom mounting bracket has an arm pivot joint and actuator pivot joint formed in a single piece.

30. An apparatus according to claim 23 wherein the at least one push arm is bent shaped so as to angle about the main pivot when the at least one push arm is extended, said at actuator connection joint is positioned approximately at an apex in the bent shaped push arm.

31. An apparatus according to claim 23 wherein the at least one boom mounting bracket is mounted with the actuator connection joint along an underside of said boom assembly.

32. An apparatus according to claim 23 wherein the at least one boom mounting bracket is mounted with the actuator connection joint along an upper side of said boom assembly.

33. An apparatus according to claim 23 wherein the boom assembly includes a first boom member and a second boom member pivotally connected to said first boom member.

34. An apparatus according to claim 23 wherein the boom assembly and grapple assembly are connected by a connection link which includes parts of said main pivot and parts of a secondary pivot, said main pivot having a main pivot axis which is oriented orthogonal to a secondary pivot axis of said secondary pivot.

35. A method of operating a boom assembly and grapple assembly which are connected at a main pivot, comprising:
extending a push arm mounted upon the boom assembly for movement using a power actuator;
engaging a roller mounted on the push arm against a trackway mounted upon the grapple assembly;
rolling the roller against the trackway by further extending the push arm;
tilting the grapple assembly relative to the boom assembly by said further extending.

36. A method according to claim 35 and further comprising:
retracting said push arm;
disengaging said roller from engagement against said trackway;
allowing said grapple to be freely suspended at said main pivot.

37. A method according to claim 35 wherein said extending a push arm and said further extending the push arm are accomplished by extending a curved push arm about the main pivot.
